(19) United States
(12) Patent Application Publication
(10) Pub. No.: US 2004/0230562 A1
(43) Pub. Date: Nov. 18, 2004

(54) System and method of providing an online user with directory listing information about an entity

(76) Inventors: Stephen J. Wysoczanski, Glenside, PA (US); Christian Frerecks, Avon, CO (US); David Barrett, Jacksonville, FL (US)

Correspondence Address: COZEN O'CONNOR, P.C., 1900 MARKET STREET, PHILADELPHIA, PA, 19103-3508, US

(21) Appl. No.: 10/848,596

(22) Filed: May 17, 2004

Related U.S. Application Data
(60) Provisional application No. 60/470,964, filed on May 15, 2003.

(51) Int. Cl. G06F 7/00

(52) U.S. Cl. 707/1

(57) ABSTRACT

A method, system, and recording medium for operating a yellow-pages type directory comprising providing a central relational database resident on a web server, the database comprising a set of primary contact records, each primary contact record including a primary key and, for each primary contact record, a set of related data records comprising the primary key of the related primary contact record, the database comprising a set of subscriber to contact record relationships. Upon receipt of related data from a subscriber, the system and method update the related record for the primary contact corresponding to the subscriber. Upon receipt of a search request from a user, preferably a primary contact record is returned to the user and either at the user's option or automatically, the related information is returned.

### CROSS-REFERENCE TO RELATED APPLICATIONS

This application claims the benefit of U.S. Provisional Application No. 60/470,964, filed May 15, 2003, which is hereby incorporated by reference.

### FIELD OF THE INVENTION

The invention relates generally to the field of on-line directory marketing, and specifically to methods, systems, and software for providing information about an entity to users.

### BACKGROUND OF THE INVENTION

The Internet has proven to be an effective communication medium. Via search, e-mail and the personalization of chosen web sites, individuals have been empowered to gather more of the information they want using less of their energy and resources. Businesses and associations are constantly looking for ways to communicate with these individuals/consumers and advertise their respective products and/or services. On-line consumers are always looking for ways to find the businesses they are interested in without spending hours searching the Internet.

Currently, businesses communicate with consumers in an on-line environment via web sites, web advertising, and e-mail marketing. E-mail is an effective form of direct communication between two parties via the Internet. A person can solicit e-mail from a web site of their choosing once they've found the web site. However, on the incoming end of an e-mail connection, the individual has limited to no control of the flow. As long as a party, any party, has an individual's e-mail address they can push their e-mail messages to that individual. Individuals, in order to get the e-mail they want, are forced to accept unsolicited e-mails. As a result, many users have come to ignore all marketing/advertising based emails, decreasing the effectiveness of this method of direct communication between marketers and on-line users/consumers.

Web sites offer a way for companies and associations to transact business or just post information via the Internet. A small percentage of businesses and association communities find web sites to be very effective and useful as source of communication with users, but a multitude of businesses have found web sites to be either cost prohibitive or not useful at all. This is especially true for smaller local businesses.

These current methods of advertising are broad solicitations made to users who may not be remotely interested in the business's product. Businesses have found that these current methods of communicating with users/customers are not financially beneficial and can be a waste of time, money, and resources. This is especially true for mid-size and local businesses. Despite the negative aspects of currently available on-line advertising and communication methods, the majority of businesses and organizations recognize the importance of being available to on-line customers and want some form of presence on the Internet that serves their purpose properly. Thus, there exists a need for a method of communication that is cheap and directly targets customers that are both interested in their business and located their local areas.

From the on-line user perspective, users desire a way to find information about particular businesses (especially local) in which they are interested without being overloaded by advertising and/or spam emails. However, current methods of communication are controlled/generated by the marketer and can be an annoyance. Thus, A need exists for a method of communication between consumers and marketers in an on-line environment that is controlled/dictated by the user.

Currently, on-line users search the Internet for information on businesses by using search engine websites such as Yahoo or Google. Searching is empowering in that it enables the user to seek and find information they want via the Internet. However, Internet searching is limited to what is available on the Internet. If a desired business/marketer chooses not to expose its information on the Internet there will be a failure to connect the user to the desired business. Failing to connect users to desired businesses is further compounded by new pay-per-search models because even businesses and organizations that do maintain web sites may not be found even if sought after.

Currently, there exists no way for individuals to gather, choose and conveniently aggregate specific sources of information on the marketers they count on at a personal/local level to one Internet-based location. As such, there is no way for marketers to simply post timely, relevant and useful messages where interested users can retrieve them at their own convenience and on their own secure terms.

The ability to personalize and/or customize has recently become available, such as “MyYahoo.” Personalization and/or customization of a web site that offers various streams of information is useful and convenient. It also saves on an individual's search effort and eliminates the need for various incoming e-mails. However, the existing reality for providers of personalized information is significant costs including, but not limited to, technology infrastructure, interface design and maintenance, and the syndication of content. They currently have no economically feasible solution for broadening their content offering to the very individual-specific local business and association driven level entities.

Considering the limitations of services currently available, there exists a need for an online user-controlled personalized contact management service utilizing structured pull technology that offers individuals customizable, secure and convenient connectivity to a timely aggregation of their chosen local businesses and associations.

From the foregoing, it can be appreciated that there is a need for a simple client relationship management tool for businesses and associations to be able to post timely, relevant and useful messages on the Internet for interested parties to gather via their personally customizable connectivity.

By providing such an efficient platform for connectivity between individuals and marketers, all parties involved will achieve a greater level of satisfaction while exerting less energy and resources. The above needs and other will be met by the present invention.

### DISCLOSURE OF THE INVENTION

It is therefore an object of the present invention to provide a method, system, and software that provide a user with more detailed information about an entity, for example a directory listing, in an online environment.

Another object of the present invention is to provide a method, system, and software that allows a user to receive information about only those entities, such as directory listings, that he/she desires.

Yet another object of the present invention is to provide a method, system, and software that allows a user to create a personalized directory in an online environment.

Still another object of the present invention is to provide a method, system, and software that allows a user to create a personalized directory in an online environment that supplies the user with updated/current information about chosen entities.

A further object of the present invention is to provide a method, system, and software that affords marketers that do not have a website the ability to provide interested customers with information and advertisements.

A still further object of the present invention is to provide a method, system, and software that affords existing online directory publishers the ability to provide updated and additional information about entities to their users.

It is another object of the present invention is to provide a method, system, and software that allows affiliated entities to provide users interested in one of the entities with information about the its affiliated entities in an unobtrusive manner.

Still another object of the present invention is to provide a method, system, and software that allows marketers to easily and cost effectively communicate with interested user's.

These and other objects are met by the present invention which in one aspect is a method of providing a user with directory listing information about an entity comprising: (a) receiving contact information for at least one entity; (b) for each entity whose contact information is received, storing the contact information in a database or file system as a primary contact file and assigning to the primary contact file a unique entity identifier; (c) receiving sublisting information for a specified entity having a stored contact file; (d) storing the sublisting information in the database or file system as a sublisting file and assigning to the sublisting file the unique entity identifier assigned to the specified entity's contact file; (e) receiving user inputted search criteria; (f) searching the database or file system for contact files that match the user inputted search criteria; and (g) displaying the contact information of matching contact files and displaying sublisting information of sublisting files having assigned unique entity identifiers that are the same as the unique entity identifiers assigned to the matching contact files.

In another aspect the invention comprises a computer-implemented method of operating a yellow-pages type directory comprising providing a central relational database resident on a web server, the database comprising a set of primary contact records, each primary contact record including a primary key and, for each primary contact record, a related data record comprising the primary key of the related primary contact record; the database further comprising a set of subscriber-to-contact record relationships; upon receipt of related data from a subscriber, updating the related record for the primary contact corresponding to the subscriber.

The method of the invention is preferably completed in a computer network environment, such as the internet. The invention enhances the connectivity between individuals requesting information (“users”) and entities, such as businesses, organizations, and/or individuals desiring to do business and communicate with potential customers (“marketers”).

In performing a preferred embodiment of the inventive method, an entity, preferably a marketer, accesses a website via a computer. The computer is connected to a network, such as the internet, which comprises the database or file system and the necessary servers to receive, transmit, and relay data. After accessing the website, the marketer first accesses a web page for creating a business profile that has data entry fields for receiving basic contact information of the marketer, such as name, address, telephone number, fax number, email address, and/or website address. The marketer then inputs its contact information in the data entry fields via a keyboard and activates a save feature. Activating the save feature automatically transmits the inputted contact information to the database or file system. Preferably, the save feature is a save button displayed on the web page that is activated by clicking on it with a mouse. Alternatively, the save feature can be activated by merely pressing the Enter Key on the keyboard when all of the data entry fields are filled.

Upon receiving the contact information inputted by the marketer, the inputted contact information is stored in the database or file system as a contact file. The marketer's contact file is assigned a unique entity identifier, which can be in the form of a numeric value or alphanumeric value. Preferably, the database stores a multitude of contact files for various marketers and individuals, each of which is assigned its own unique entity identifier. The contact files can be stored in table format comprising rows and columns. It is further preferable that upon creating a contact file, the marketer be assigned a password that will identify the marketer to the database or file system during future transactions.

Upon a contact file being stored in the database or file system for a specific marketer, that marketer can input sublisting information to display to consumers that view its contact information stored in its contact profile. Sublisting information can be, for example, an advertisement message, an hyperlink, an attached file, an executable file, extensible markup language, or hypertext markup language. In order to enter sublisting information, the marketer preferably logs onto the website again in the future using its password and accesses a web page that has data entry fields for receiving sublisting information. The marketer inputs its sublisting information into the appropriate data entry fields and activates a posting feature. The posting feature is preferably a post button or a save button displayed on the web page. Activating the positing feature transmits the sublisting information to the database or file system. The transmitted sublisting information is then stored on the database or file system as a sublisting file and assigned the same unique entity identifier that assigned to the marketer's contact file. When a multitude of marketer's input sublisting information, sublisting files are created for each marketer and assigned the same unique entity identifier that is assigned to that specific marketer's contact file. The sublisting information stored in a stored sublisting file can be updated and changed as desired. Additionally, each marketer can create a plurality of sublisting files. The sublisting files can be stored on the database or file system in table format comprising rows and columns.

Once the contact profiles and sublisting profiles are stored in the database or file system for a plurality of marketers, a user can then access the website via a computer connected to the network. From the user perspective, the user then accesses a web page on the website that has data entry fields for receiving search criteria. Depending on the user's needs, the user inputs search criteria in the data entry fields and activates a search feature. The search feature is preferably a search button on the web page that is activated by clicking on it with a mouse controlled pointer. By activating the search feature, the search criteria is transmitted and a search of the database or file system for stored contact files that match the user inputted search criteria is initiated. Upon finding matching contact files, a search of the sublisting files stored on the database or file system is automatically performed, looking for sublisting files that have assigned unique entity identifiers that are the same as the unique entity identifiers assigned to the contact files that have been determined to match the user inputted search criteria. The search results data is then transmitted back to the user's computer and displayed on a search results web page. The search results page displays: (1) the contact information of all contact files found to match the user inputted search criteria; and (2) all sublisting information of sublisting files found to have assigned unique entity identifiers that are the same as the unique entity identifiers assigned to the matching contact files. Thus, for each marketer determined to be a match to the search criteria, the user views the marketer's contact information and all sublisting information that the marketer posted. Preferably, the sublisting information for each marketer is displayed beside the corresponding marketer's contact information.

It is further preferable that upon accessing the website for a first time, the user be required to input its contact information in a manner similar to that described above for the marketer. The user inputted contact information is then transmitted and stored on the database or file system as a contact file and assigned a unique entity identifier. Therefore, the user's contact information is stored in the database or file system as a contact file and is searchable by other users. The user can also have an option to add sublisting information to be related to his/her contact file in a manner similar to that described above for the marketer.

Optimally, the invention further affords entities having a stored contact file to associate themselves with other entities having a stored contact in contact/subcontact relationship. In this embodiment, a first entity having a stored contact file designates the stored contact file of a second entity as a sub-contact. This can be done on a web page of the website by entering the appropriate information into data entry field or selecting a desired contact file from a list of stored contact information. Once the first entity designates a second entity as a subcontact, a relationship file is created on the database or file system that relates the unique entity identifier of the contact file of the second entity with the unique entity identifier of the contact file of the first entity. The relationship file stores the unique entity identifier of the contact file of the first entity in a contact column while the unique entity identifier of the contact file of the second entity is stored in a subcontact column within the same row as the first entity's unique entity identifier. When relationship files are created and stored on the database or file system, and a user perform a search of the contact files as described above, a search of the relationship files will also be undertaken for relationship files that contain unique entity identifiers that are the same as the unique entity identifiers of contact files determined to match the user inputted search criteria. Thus, when the search results are displayed on the user's computer, the display will further include the contact information stored in the contact profile of the entity designated as a subcontact of the entity whose contact profile was determined to match the search criteria.

In a further preferred embodiment, the invention further comprises the ability for the user to select from the search results web page the contact information for an entity that the user desires to add to his/her personal contacts list. Once the user selects the desired contact information, a user file is created and stored in the database or file system for that user. The user file contains a relationship between the unique entity identifier assigned to the user's contact file and the unique entity identifier assigned to the contact file of the entity selected to be added by the user. Thus, when the user accesses a personal contact list web page on the website, the user's user file will be retrieved and the contact information of all contact files whose unique entity identifier is stored in the user file will be displayed therein. Preferably, the sublisting information of all sublisting files having assigned unique entity identifiers that are the same as the unique entity identifiers of the contact files whose unique entity identifier is stored in the user file will also displayed. Thus, when a user accesses his/her personal contact list web page, both the contact information and the sublisting information for the marketers the user has added as personal contacts is retrieved and displayed. The sublisting information is the most recently updated sublisting information posted by the marketer.

In another aspect, the invention is accomplished by using businesses offering directory lookup and listing services, such as Directory Service Providers (“DSPs”). DSPs include traditional Yellow Pages Publishers, Internet Yellow Pages Publishers, Newspapers, and Portals (also referred to as “online directory publishers”). As used herein, portals are web sites that aim to be an entry point to the World Wide Web (“WWW”), typically offering a search engine and/or links to useful pages, and possibly news or other services. A secure online interface, linking at least one database or file system with at least one web-based server is used. The web-based server is preferably linked by the secure online interface to the at least one database or file system and provides an on-line listing data retrieval system, a distribution and return routing system, a lead generation system, and a tracking system.

In this aspect, the invention is a method for online directory publishers to provide a user with additional directory listing information about an entity comprising: (a) providing an online directory publisher website having a web page with data entry fields for receiving search criteria; (b) receiving user inputted search criteria in the data entry fields of the directory publisher website; (c) transmitting the inputted search criteria to a proxy server; (d) transmitting the inputted search criteria from the proxy server to a database or file system storing contact information for a plurality of entities as contact files, each contact file having a unique entity identifier assigned thereto, the database or file system further storing sublisting information for specified entities having contact files, the sublisting information being stored as sublisting files, and each sublisting file having assigned thereto the unique entity identifier that is assigned to the specified entity's contact file; (e) searching the database or file system for stored contact files that match the inputted search criteria that was transmitted from the proxy server; (f) upon finding stored contact files that match the inputted search criteria, retrieving sublisting files having assigned unique entity identifiers that are the same as the unique entity identifiers assigned to the matching contact files; (g) transmitting the retrieved sublisting files from the database or file system to the proxy server; and (h) displaying on a results web page of the directory publisher website the sublisting information of the retrieved sublisting files.

The online directory publisher web site preferably resides on the directory publisher's web-based server. An applet is preferably embedded in a web page of the web site for packeting and transmitting the search criteria and other data to and from the database or file system. Other preferred methods include communicating the search criteria by an externalized program or script which calls a program on the web site to obtain the information.

The contact files and sublisting files stored on the database or file system can be inputted and created using a separate web site or the directory publisher web site. Specifically, and preferably, the contact information for a plurality of entities is stored as contact files on the database or file system by an entity accessing a separate web site having a web page with data entry fields for receiving contact information, the entity inputting its contact information in the data entry fields, and activating a save feature that automatically stores the inputted contact information in the database or file system as a contact file and assigns a unique entity identifier to the contact file. Additionally, the sublisting information stored on the database or file system as sublisting files can be created by an entity logging on to a separate web site using a password that identifies the entity; the entity accessing a web page with data entry fields for receiving sublisting information; the entity posting sublisting information desired to be displayed; and activating a posting feature that automatically stores the posted sublisting information as a sublisting file in the database or file system and assigns to the sublisting file the unique entity identifier that is assigned to the entity's contact file. In another preferred method, sublisting information can be obtained by reading another web site and allowing a subscriber to select some or all information to add as a sublisting. Such process of going out to other web sites to obtain sublisting information for a subscriber can be automated so that the system automatically plucks information from the external web site to use as a sublisting. Such process can be easily automated according to known procedures.

In this aspect, it is preferred that the method also comprise the steps of searching a directory publisher database for stored contact files that match the inputted search criteria; and displaying on the results web page of the directory publisher website information within contact files that match the inputted search criteria, the sublisting information of the retrieved sublisting files being displayed next to the displayed information of the contact files that match the inputted search criteria from the directory publisher database.

As with the first inventive method, the unique entity identifier can be a numeric value or alphanumeric value and the entity can be an individual person or a business. The sublisting information can be an advertisement message, an hyperlink, an attached file, an executable file, extensible markup language, or hypertext markup language.

The inventive method using the online directory publisher website can also include the ability to display subcontact information for marketers. In this embodiment, the method further comprises the step of designating a contact file for a first entity stored on the database or file system as a sub-contact of a stored contact file of a second entity stored on the database or file system. Upon the contact file of the second entity being found to match the user inputted search criteria during the completion of step (e), steps (f) through (h) further include retrieving the contact file for the first entity, transmitting the contact file for the first entity from the database or file system to the proxy server, and displaying on the results web page of the directory publisher website the contact information of the contact file for the first entity as a sub-contact of the contact information displayed of the contact file for the second entity.

Regarding the secure online website interface that links the database or file system with the web-based server, the web-server server will preferably access the database or file system to identify a specific level of listing data not found on the online directory publisher's database to be included in a users personalized directory portal page. The combination of the directory publisher's database and the database or system file of the present invention can identify the rules established by the listing organization to facilitate the retrieval of additional data requirements and click-through distribution. It is further preferable that a distribution or service offer or solicitation be activated within the listing results application on the directory publisher's server.

Moreover, the system and method will preferably recognize the action associated with the return notification in providing return notification to the user regarding the level of service being made available by the listing entity and if no service is available automatically activates a notification application. The database or file system of the invention, via a server, will preferably identify a non-active listing as a qualified sales lead, for the purpose of notifying the directory publisher's server automatically as scheduled and provide a detailed activity report. The database or file system of the invention can then automatically generate a notification to the non-registered listing entity. This notification can be customized to reflect the directory publisher's unique brand identity. Specific contact and activity reports can be also generated on demand.

In yet another aspect, the invention is a system for providing a user with directory listing information about an entity comprising: a server connected to at least one user computer; a database or file system stored on or connected to the server; means for receiving contact information of entities; means for storing received contact information on the database or file system as contact files; means for assigning a unique entity identifier to each contact file stored; means for receiving sublisting information relating to a specified entity having a stored contact file; means for storing received sublisting information as a sublisting file on the database or file system; means for assigning the unique entity identifier assigned to the specified entity's contact file to the specified entity's sublisting file; means for receiving user inputted search criteria; means for searching the database or file system for stored contact files that match the user inputted search criteria; means for searching the database or file system for sublisting files having assigned unique entity identifiers that are the same as the unique entity identifiers assigned to contact files that are determined to match the user inputted search criteria; means for displaying the contact information of contact files that match user inputted search criteria and displaying sublisting information of sublisting files having unique entity identifiers that are the same as the unique entity identifiers assigned to the contact files that match the user inputted search criteria.

In another aspect, the invention comprises a recording medium such as a memory circuit or hard drive, for example, on which a computer-readable program is recorded, the program comprising code for a central relational database comprising a set of primary contact records, each primary contact record including a primary key; a set of related data records, each related data record comprising the primary key of a related primary contact record, the relational database; and a set of subscriber to contact record relationships; code for authenticating a subscriber client to establish, modify, and/or remove related data records and, upon receipt of commands and data from an authenticated subscriber, updating a related data record. The recording medium can comprise comprising code for assigning an incremented primary key numeric or alphanumeric value to each new contact entered into the database and can be programmed to receive search request criteria from a user and return one or more primary contact records matching the search criteria, and to either automatically return the related data to the user or to return the related data for a primary contact at the users option.

### BRIEF DESCRIPTION OF THE DRAWINGS

FIG. 1 is an example of a home page for a yellow pages type directory on a web server according to the invention.

FIG. 2 is a registration page according to the present invention.

FIG. 3 is a user, enterprise (subscriber), publisher identification page according to the present invention.

FIG. 4 is an enterprise type choice page according to the present invention.

FIG. 5 is subscriber option page according to the present invention.

FIG. 6 is an enterprise additional information update page according to the present invention.

FIG. 7 is a flow chart illustrating an embodiment of the invention.

FIG. 8 illustrates a personal contacts list page for a logged in user.

FIG. 9 illustrates an expanded contact listing showing placement of any sublisting information.

### DETAILED DESCRIPTION

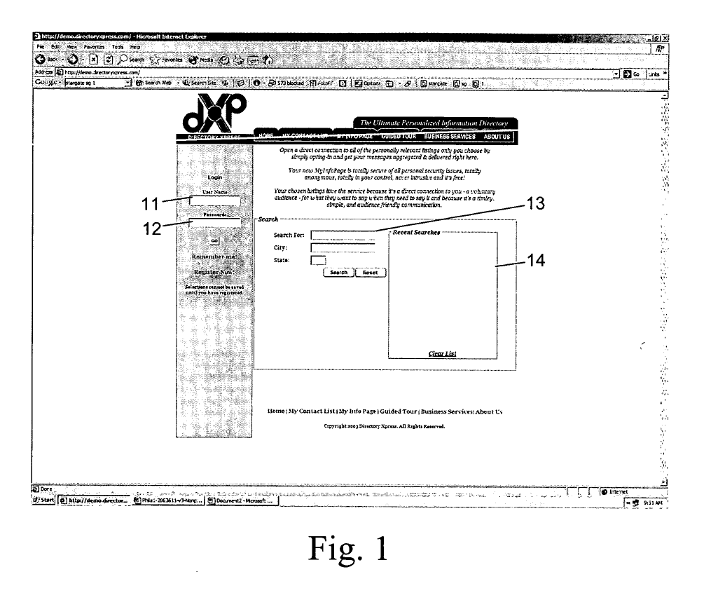

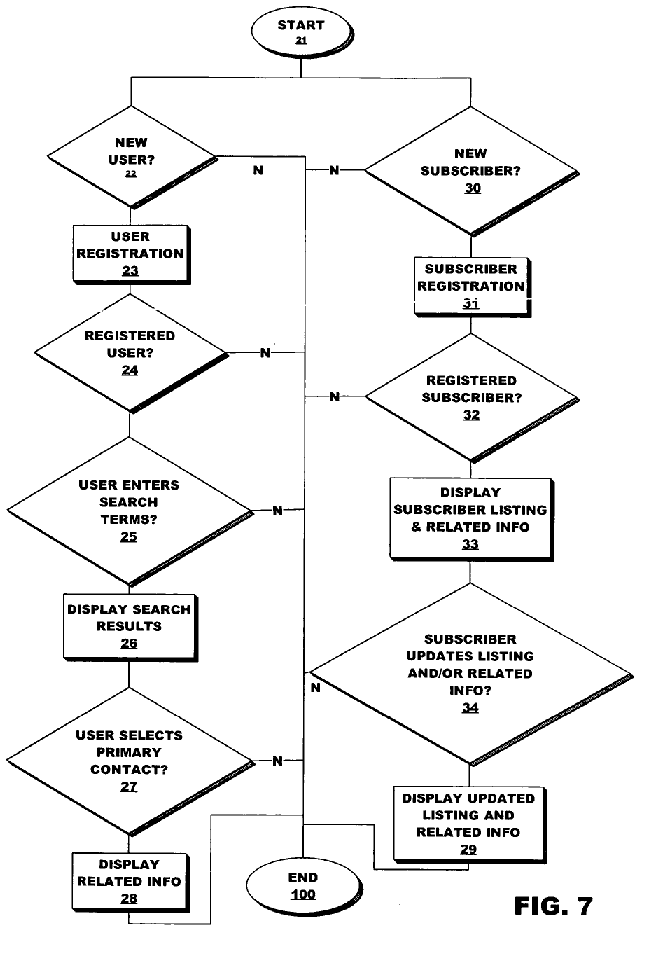

Referring first to FIG. 7, a flow chart of a method according to the invention is illustrated starting 21 with the client addressing the web page displayed by the web server system and code residing on a web server. A web page as illustrated in FIG. 1 is displayed wherein the user can log in at 11, enter password 12, or can enter search criteria 13 without logging in. If the user is identified, either by logging in or by cookies or some other method, the system looks up and displays the user's most recent search results. If the user is a new user, 22 in FIG. 7, then the system allows registration 23 at this point. If the new user registers, 24, then the user may enter 25 search terms and a search is run and search results are displayed 26.

In response to the search results, which usually will include one or more primary listings as with conventional on line yellow page-type directory searches, the system allows the user to select any listing 27 (also referred to as a primary contact) and view any additional information associated with the listing in the relational database which is displayed 28.

If a client is a registered subscriber 32 or wishes to become a new subscriber 30, a login process or subscriber registration process 31 similar to that for a user client 23, 24 is used. Upon successful subscriber authentication 32 or new subscriber registration, which preferably comprises providing a subscription fee, the subscriber may view 33 its current listing and any related information currently in the system, and then may update 34 a current listing and/or may revise, by adding to, modifying, or deleting, related information. Finally, the updated listing and related information are displayed 35 for the subscriber, and then the process is completed 100.

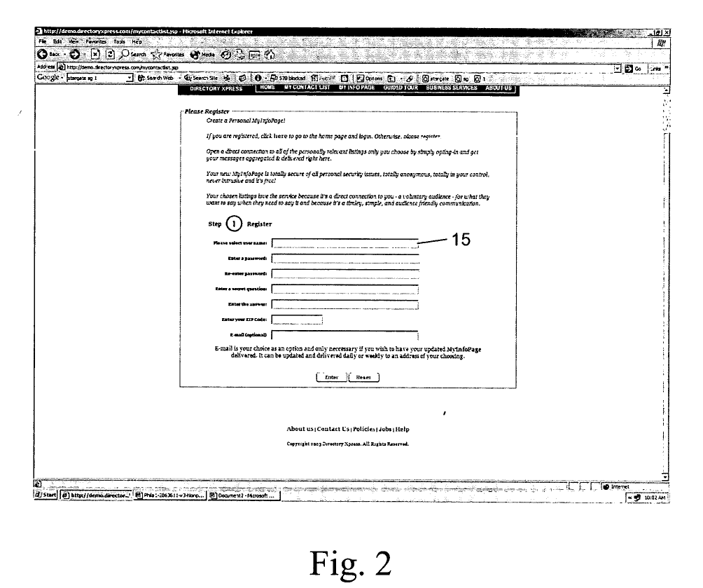

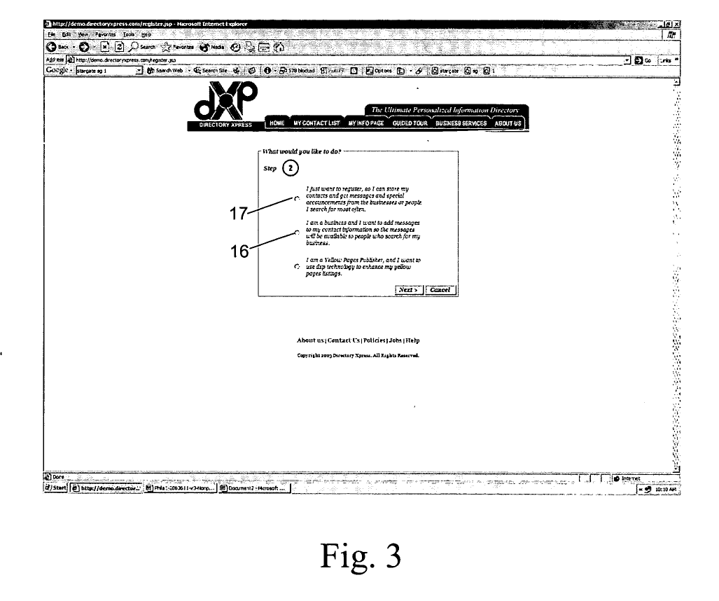

FIG. 2 illustrates a web page which can be used for new user or new subscriber registration. For users, there is preferably no fee, as is the custom with internet searching tools, but for subscribers, a fee is charged for the ability to add related information to its primary listing. As illustrated in FIG. 3, during the registration process, the client is queried as to whether it is a user 17, a subscriber 18, or a directory publisher. For example, if the client is a user 17, by registering the user may store previously viewed contacts, i.e., primary listings; which are similar to yellow pages listings, showing entity name, address, phone, possibly fax and/or map information. If the client is a registered subscriber 18, the client may add additional information to its listing, for example web site, hours of operation, featured specials, offerings, discounts, driving directions, and any other type of information which is customarily displayed on an entity's own web site. An advantage of the present invention is that the subscriber does not have to maintain its own web site, or can have an additional source of related information about itself available to users directly who are doing a yellow pages type search through a directory.

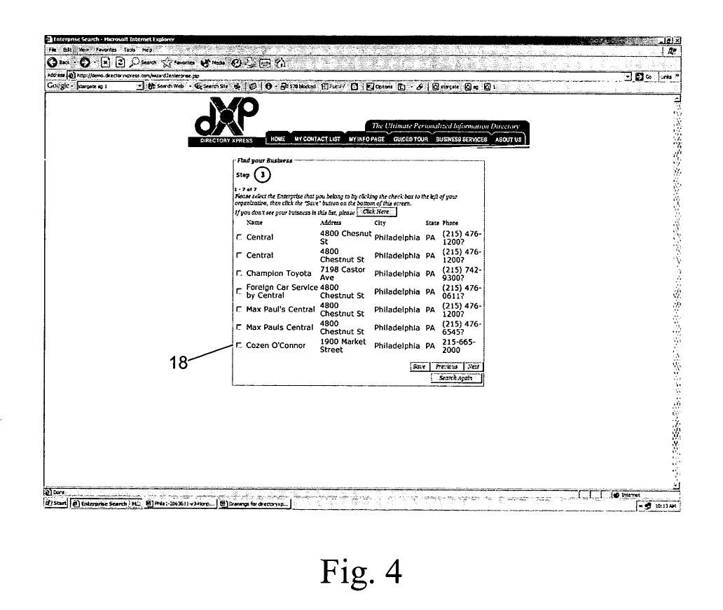

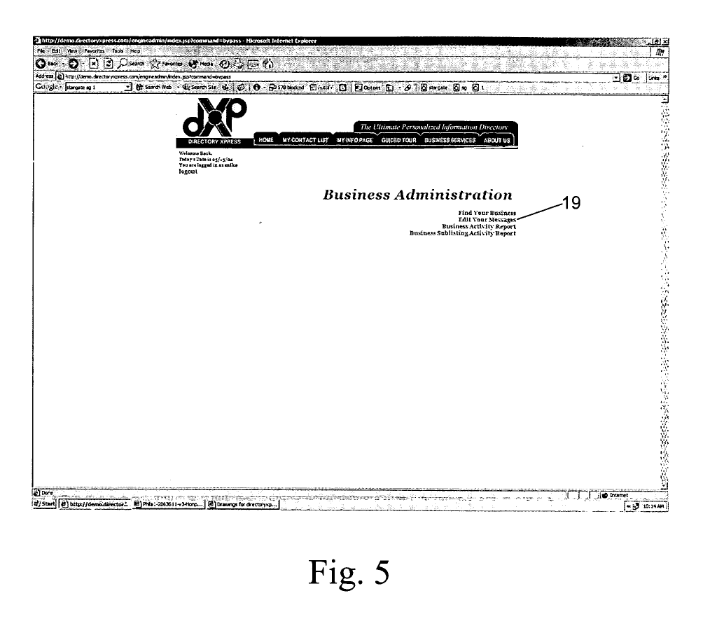

FIG. 4 illustrates a web page wherein the enterprise may select the type it belongs to, and FIG. 5 illustrates a page where an enterprise has been authenticated and may chose to edit 19 its messages, i.e., its additional, related information which will be available to a user who clicks on a contact, or directory listing, after finding it in a search.

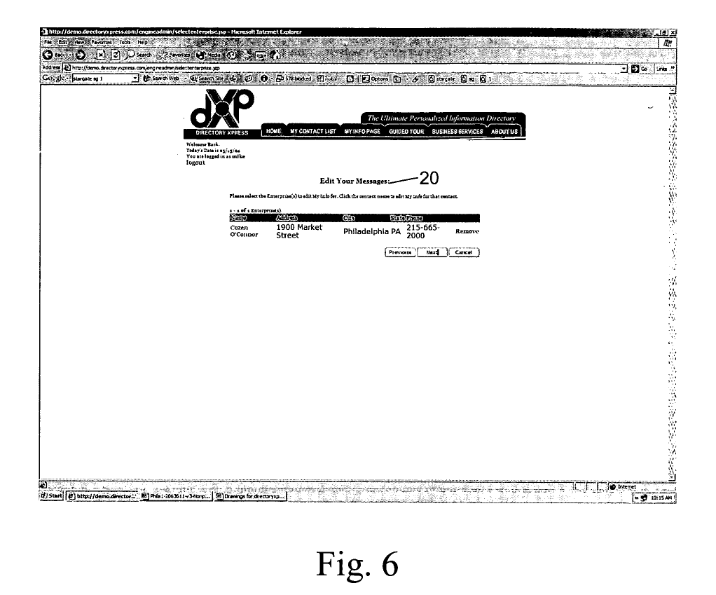

FIG. 6 illustrates a web page wherein an authenticated enterprise can update its additional information.

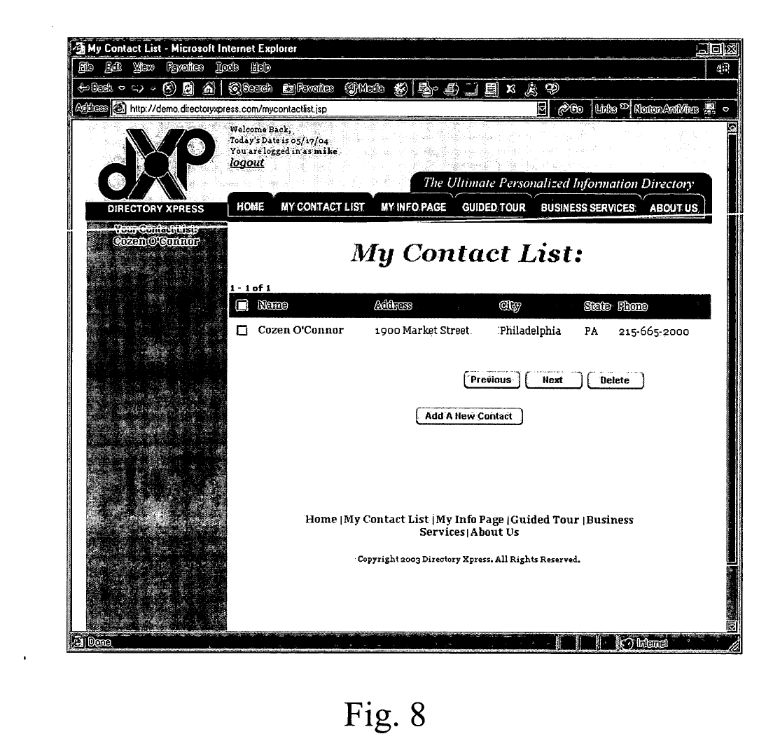

FIG. 8 illustrates a personal contacts list page for a logged in user. In the illustrated embodiment, this user only has one personal contact.

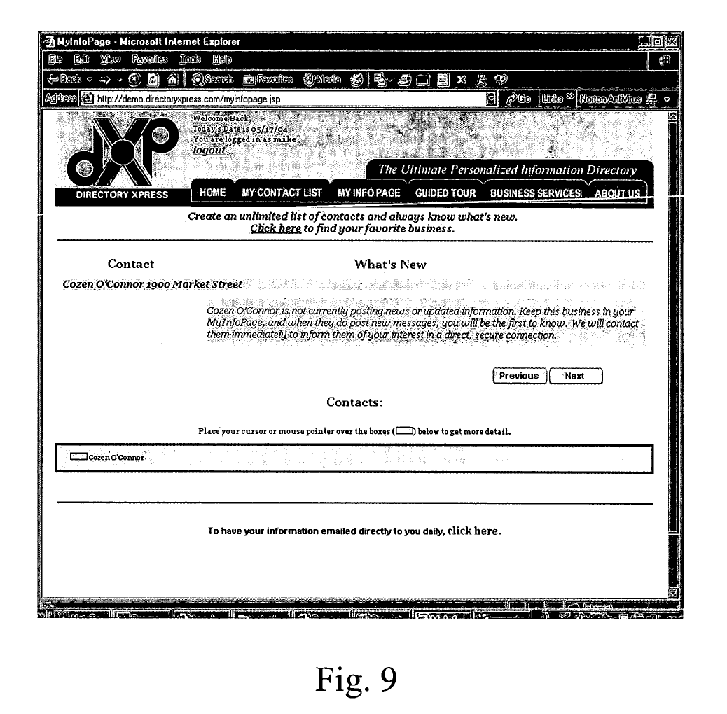

FIG. 9 illustrates an expanded contact listing showing placement of any sublisting information. In this illustration, no sublisting information for the listing is present.

It will be appreciated by those skilled in the art that many other embodiments, alternatives, and modifications to the invention are possible without departing from the spirit and scope of the invention.

What is claimed is:

1. A computer-implemented method of operating a yellow-pages type directory comprising
providing a central relational database resident on a web server, the database comprising a set of primary contact records, each primary contact record including a primary key and, for each primary contact record, a related data record comprising the primary key of the related primary contact record;
the database further comprising a set of subscriber-to-contact record relationships;
upon receipt of related data from a subscriber, updating the related record for the primary contact corresponding to the subscriber.

2. The method of claim 1 wherein the related record comprises one or more advertisement, image, URL, document, video, data in HTML format, or audio.

3. The method of claim 1 wherein the primary contact record is a directory listing comprising contact name, address, and phone number fields.

4. The method of claim 1 wherein primary contact records can be entered, deleted, and modified, and an incremented primary key value is assigned to each new contact record entered into said database.

5. The method of claim 1 wherein subscriber clients are authenticated by use of cookies and/or passwords, and an authenticated subscriber client is permitted to update the primary contact record related to said authenticated subscriber and an authenticated subscriber client is further permitted to revise the primary contact record.

6. The method of claim 1 further comprising receiving directory search requests comprising search criteria from a user, returning primary contact record data which match search request criteria, and returning related records to the user either automatically or upon selection by the user.

7. The method of claim 1 wherein the search request and returning of records are facilitated by an applet

8. The method of claim 1 wherein the related records comprise one or more related contact records.

9. The method of claim 1, wherein the authenticated subscriber enters updated related data and/or updated contact data via a web page which comprises a posting feature.

10. The method of claim 9 wherein the posting feature is a post button or a save button displayed on the web page with the data entry fields for receiving said related data.

11. The method of claim 1 wherein the database comprises a table of previously-accessed primary contact records which correspond to users so that when a user accesses the directory, a list of primary contact records previously accessed can be returned.

12. The method of claim 11 further including identifying a user when the user opens a directory page on the web server, storing a personal contact list for the user, and returning the personal contact list when an identified user opens the directory page, thereby facilitating the user's recollection of previously chosen contacts.

13. The method of claim 1 wherein a subscriber is authenticated upon payment of a subscription fee and is denied authentication upon failure to pay the subscription fee.

14. The method of claim 1 wherein the primary key is a numeric value or alphanumeric value.

15. The method of claim 1 wherein the primary key is a numeric value or alphanumeric value.

16. A system for processing information comprising
a web server programmed to store a central relational database comprising a set of primary contact records, each primary contact record including a primary key; a set of related data records, each related data record comprising the primary key of a related primary contact record, the relational database; and a set of subscriber-to-contact record relationships;
the web server programmed to authenticate a subscriber client to establish, modify, and/or remove related data records and, upon receipt of commands and data from an authenticated subscriber, updating a related data record.

17. The system of claim 16 wherein the related records comprise one or more advertisement, image, URL, document, video, data in HTML format, or audio.

18. The system of claim 16 wherein the server is programmed to assign an incremented primary key numeric or alphanumeric value to each new contact entered into the database.

19. The system of claim 16 programmed to receive search request criteria from a user and return one or more primary contact records matching the search criteria, and to either automatically return the related data to the user or to return the related data for a primary contact at the users option.

20. A recording medium on which a computer-readable program is recorded, the program comprising
code for a central relational database comprising a set of primary contact records, each primary contact record including a primary key; a set of related data records, each related data record comprising the primary key of a related primary contact record, the relational database; and a set of subscriber to contact record relationships;
code for authenticating a subscriber client to establish, modify, and/or remove related data records and, upon receipt of commands and data from an authenticated subscriber, updating a related data record.

21. The recording medium of claim 20 further comprising code for assigning an incremented primary key numeric or alphanumeric value to each new contact entered into the database.

22. The recording medium of claim 20 further programmed to receive search request criteria from a user and return one or more primary contact records matching the search criteria, and to either automatically return the related data to the user or to return the related data for a primary contact at the users option.
